(19) United States
(12) Patent Application Publication
(10) Pub. No.: US 2006/0204426 A1
(43) Pub. Date: Sep. 14, 2006

(54) Methods and devices for making carbon nanotubes and compositions thereof

(75) Inventors: Daniel L. Akins, Teaneck, NJ (US); Hui Yang, Corona, NY (US)

Correspondence Address: DARBY & DARBY P.C., P. O. BOX 5257, NEW YORK, NY, 10150-5257, US

(73) Assignee: Research Foundation of the City University of New York, New York, NY (US)

(21) Appl. No.: 11/280,919

(22) Filed: Nov. 16, 2005

Related U.S. Application Data
(60) Provisional application No. 60/629,204, filed on Nov. 17, 2004.

(51) Int. Cl. C01B 31/02; B32B 27/04

(52) U.S. Cl. 423/445 B; 422/150

(57) ABSTRACT

A method of making carbon nanotubes includes reacting hydrogen and carbon monoxide in a reaction chamber and in the presence of stainless steel. Typically, the carbon nanotubes are formed on the stainless steel. These carbon nanotubes can be removed from the stainless steel and can be used in a variety of applications.

### CROSS-REFERENCE TO RELATED APPLICATIONS

This application claims the benefit under 35 USC 119(e) of U.S. Provisional Patent Application No. 60/629,204, filed on Nov. 17, 2004, which provisional application is incorporated herein by reference in its entirety.

### STATEMENT REGARDING FEDERALLY SPONSORED RESEARCH OR DEVELOPMENT

The present inventions were supported, at least in part, under DAAD-19-01-1-0759; Grant No. 42501EL from the United States Army Research Office. The Government of the United States may have certain rights in the inventions.

### FIELD

The present inventions are directed to methods and devices for making carbon nanotubes, as well as the carbon nanotubes made therewith. The present inventions are also directed to methods and devices for making carbon nanotubes in the presence of stainless steel, as well as the carbon nanotubes made therewith.

### BACKGROUND

Since their discovery in 1993, carbon nanotubes have attracted attention because of their structural, mechanical, and electrical properties. Single-walled carbon nanotubes (SWNTs) have been synthesized using a variety of processes including laser vaporization, carbon arc discharge, and chemical vapor deposition (CVD). These methods typically form self-assembled bundles of individual tubes that have a range of diameters and chiralities (spiral angles). The diameters and chiralities, collectively as well as individually, affect the physical, chemical, optical, and electronic properties of the nanotubes. These nanotubes can be particularly useful in fields such as, for example, nanotechnology.

### BRIEF SUMMARY

One embodiment of the inventions is a method of making carbon nanotubes. The method includes reacting hydrogen and carbon monoxide in a reaction chamber and in the presence of stainless steel. Carbon nanotubes are formed as a result of the reaction. Typically, the carbon nanotubes are formed on the stainless steel. These carbon nanotubes can be removed from the stainless steel and can be used in a variety of applications such as electronic and mechanical applications, including nano-electronic and nano-mechanical applications.

Another embodiment of the inventions is a composition including carbon nanotubes formed in the presence of stainless steel.

Yet another embodiment of the inventions is a device for forming carbon nanotubes. The device includes a chamber with one or more inlets for receiving gas; and a stainless steel object disposed in the chamber upon which the carbon nanotubes are formed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of a device for forming carbon nanotubes, according to the inventions;

FIG. 2 is a Raman spectrum of the G- and D-bands for carbon nanotubes formed in the presence of stainless steel, according to the inventions;

FIG. 3 is a Raman spectrum of the radical breathing mode region for carbon nanotubes formed in the presence of stainless steel, according to the inventions; and

FIGS. 4A and 4B are Raman spectra of the G- and D-bands and the radical breathing mode region for carbon nanotubes made under two different sets of conditions.

### DETAILED DESCRIPTION

The present inventions are directed to the area of methods and devices for making carbon nanotubes, as well as the carbon nanotubes made therewith. The present inventions are also directed to methods and devices for making carbon nanotubes in the presence of stainless steel, as well as the carbon nanotubes made therewith.

Conventional methods for forming carbon nanotubes have generally been unsatisfactory for a number of reasons. Chemical vapor deposition (CVD) methods typically have lower nanotube formation temperatures than other methods, but CVD methods have generally required the use of nanoparticle catalysts (often metallic nanoparticles). Although the particulate catalyst can facilitate the formation of carbon nanotubes, these particles can also contaminate the nanotube product and can be difficult to remove. Moreover, the properties of the nanotubes can depend on the nanotube size distribution which is affected by the size distribution of the nanoparticle catalysts.

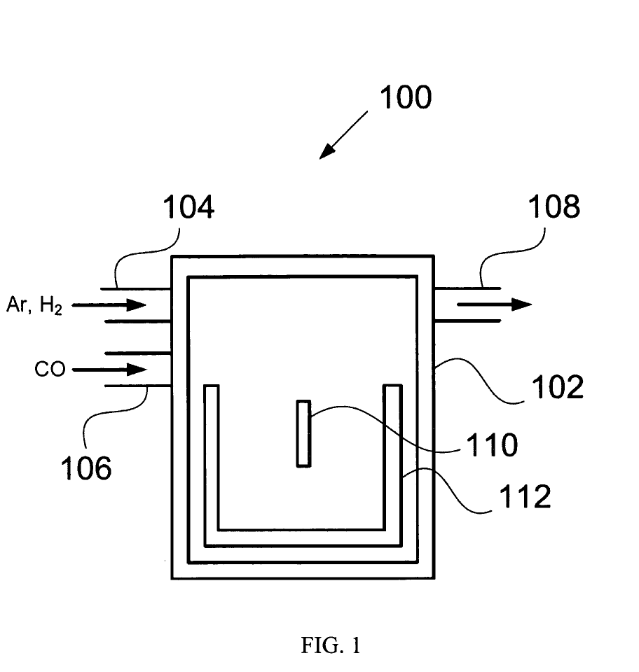

Instead of using added nanoparticle catalyst, stainless steel (for example, bulk stainless steel) can be used to form carbon nanotubes by CVD. Although not wishing to be bound by any particular theory, it is believed that the stainless steel inherently has surface catalytic sites. The nanotubes are a reaction product of hydrogen and carbon monoxide in the presence of the stainless steel, and, preferably, on the stainless steel. FIG. 1 illustrates one embodiment of a device for forming carbon nanotubes. The device 100 includes a chamber 102, one or more inlets/outlets 104, 106, 108 for flow of gas into or out of the chamber, a stainless steel object 110, and a heating mechanism 112. In will be recognized that suitable devices may include a variety of other items including, for example, pressure gauges, temperature gauges and flow meters.

Generally, any chamber 102 suitable for CVD processes can be used, such as quartz or stainless steel. The chamber 102 includes a heating mechanism 112 to heat the interior of the chamber. One or more inlets/outlets 104, 106, 108 are provided to allow for the flow of gas. In some embodiments, mixtures of gases can be provided through a single inlet. In other embodiments, mixtures of gases can be provided by adding the individual gases through separate inlets.

The stainless steel object 110 is placed in the chamber 102 and can be held in place using clips, a platform, or the like or the stainless steel object can be suspended from the ceiling of the chamber. The stainless steel object can have any shape such as, for example, a tube, rod, sphere, or cone. In other embodiments, the stainless steel object can be a piece of stainless steel held in another item. For example, a bulk stainless steel object can be placed in the center of a tube, for example, a quartz tube.

Any stainless steel can be used, principally due to its alloy nature. In particular, austenitic stainless steels are useful including, but not limited to, 316 stainless steel. The inherent surface catalyst present in stainless steel acts as catalytic sites for the growth of carbon nanotubes.

Generally, prior to adding the reactants for formation of the nanotubes, the chamber is purged using an inert gas or one of the reactant gases to remove air (and, in particular, oxygen) from the chamber. Examples of suitable inert gases include, but are not limited to, argon and nitrogen. The purging gas pressure is typically in the range of 0.5 to 10 atmospheres (atm) (about 5×10⁴ to 1×10⁶ Pa). In at least some embodiments, this purging occurs for at least 30 minutes. Purging may not be needed or may be used for a shorter period of time if the chamber has not been exposed to air.

In at least some embodiments, during purging the chamber is heated to further degas the chamber. In one embodiment, the chamber is heated to a temperature in the range of 650 to 1200° C. In one embodiment, the chamber is heated at or near the reaction temperature.

After purging with an inert gas, the chamber is optionally purged with hydrogen. This second purging can occur for at least 5 minutes and, preferably, about 30 minutes or more.

The reactants, hydrogen and carbon monoxide, are then flowed into the chamber. The relative amounts of reactants can range from pure carbon monoxide (100% CO) to 80% (by volume) H₂/20% CO. Typically the relative amounts of reactants range from 40% H₂/60% CO to 20% H₂/80% CO. The total pressure is typically at least 1 atm (about 10⁵ Pa). Generally, the total pressure is in the range of 1 to 10 atm (10⁵ Pa to 10⁶ Pa), but can be higher. If no hydrogen is provided at this point in the process, the carbon monoxide will react with the hydrogen used in the previous hydrogen purging process.

The reaction temperature is typically at least about 650° C. Typically, the reaction temperature does not exceed 1200° C. Generally, the temperature is in the range of 650° C. to 1200° C. and, preferably in the range of 800° C. to 1000° C.

The reaction time can vary depending on factors such as the reaction mixture, reaction pressure, reaction temperature, size of the stainless steel object, size of the chamber, type of stainless steel, and the relative amounts of reactants. In at least some embodiments, the reaction time is at least 15 minutes and may extend 90 minutes or more.

After the reaction is completed, the gas mixture in the chamber can be changed to pure hydrogen or an inert gas, such as argon, and this gas can flow at the reaction temperature for a period of time (e.g., 30 minutes or more) to remove unreacted CO. The temperature of the chamber can then be slowly reduced to room temperature while the hydrogen or inert gas continues to flow for a period ranging from 30 minutes to 2 hours or more.

The carbon nanotubes are typically formed as black, hair-like or paper-like entities disposed on the stainless steel. The nanotubes can often be brushed off the surface of the stainless steel to recover the nanotubes. The nanotubes can typically be purified by simple washing procedures, such as refluxing under HNO₃/HCl (3:1) at ca. 90˜100° C. Carbon nanotubes formed using this method can have a relatively narrow diameter distribution near 1 nanometer. The mean diameter of the carbon nanotubes can depend on the reaction temperature and ratio of hydrogen to CO. In one embodiment, the mean diameter of the carbon nanotubes is in the range of 0.8 to 1.2 nm.

The nanotubes can be used in a variety of applications. Such applications include, but are not limited to, use in electronic and mechanical devices such as nano-electronic and nano-mechanical devices.

### EXAMPLE

A laboratory constructed CVD chamber was used. A 316 stainless steel tube having a width of 25 mm and length of ca. 200 mm was positioned in the CVD chamber. Highly purified (99.999%) argon gas at a pressure of ca. 1 atm was used to purge the chamber for more than 30 minutes to remove air. The chamber was raised to a temperature of 700° C. during the purging period.

After purging with argon, the chamber was filled with hydrogen to a pressure of 1 atm and the chamber temperature was maintained at 700° C. for about 30 minutes. Next, a mixture of carbon monoxide and hydrogen gas (4:1 by volume) was allowed to flow into the chamber until a total pressure of about 5 atmospheres (about 5×10⁵ Pa) was reached. The temperature and pressure was maintained for 40 minutes during which the carbon nanotubes grew on the stainless steel tube.

Next, the gas mixture entering the chamber was changed to pure hydrogen or argon (1 atm) and the temperature was maintained at 700° C. for about 30 minutes. The reactor was then slowly cooled to room temperature (over ca. a 1 h period) under the flowing inert gas or hydrogen. Black, paper-like carbon sheets of carbon nanotubes were removed from the surface of the stainless steel tube.

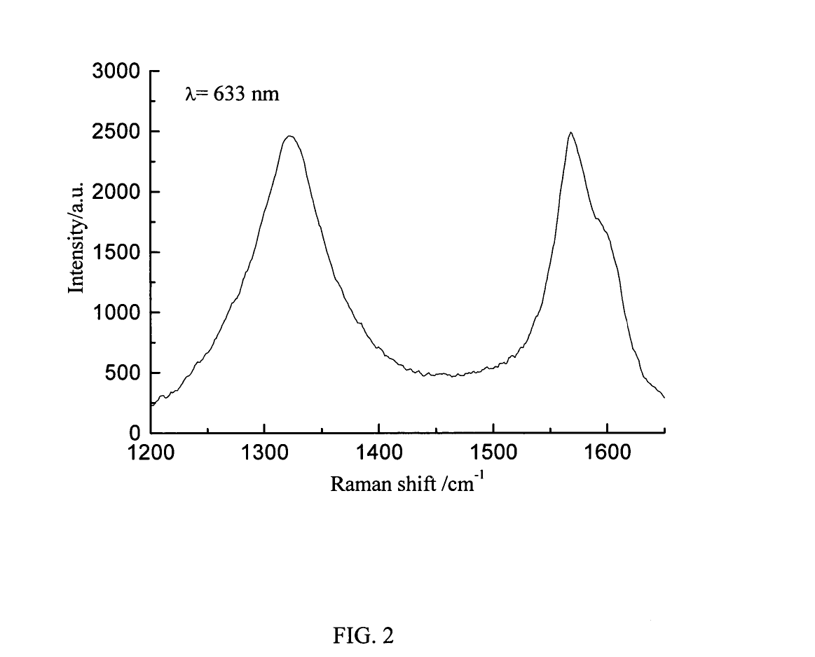

The carbon nanotubes were characterized by microRaman spectroscopy using a LabRam Raman spectrometer from Horiba Jobin Yvon, Edison, N.J. FIG. 2 is a Raman spectrum of carbon nanotubes excited with 632 nm radiation. The Raman spectrum contains the D-band and G-band that are characteristic of carbon nanotubes. Specifically, the band at 1576 cm⁻¹ is assigned to the G-band of ordered carbon, while the Raman band at 1324 cm⁻¹ is attributable to disordered carbon (e.g., defects in the carbon nanotubes).

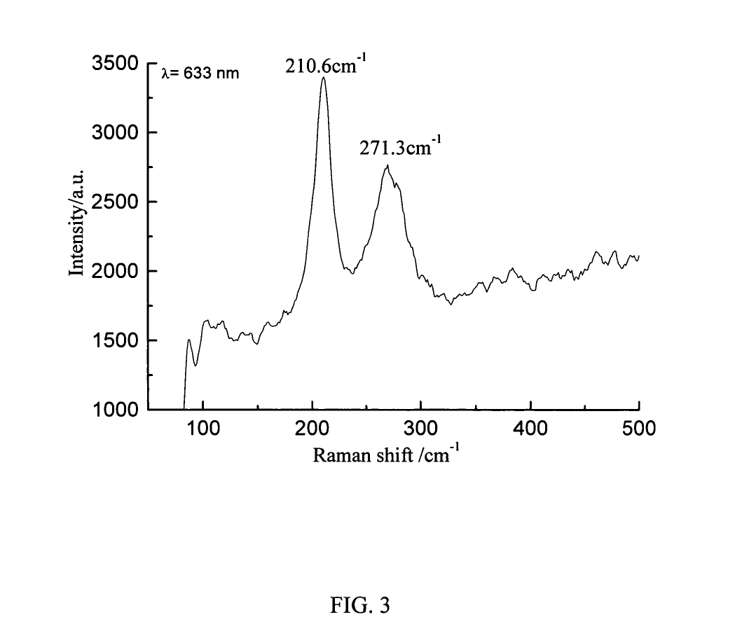

FIG. 3 is a Raman spectrum in the radical breathing mode (RBM) region and indicates that the nanotubes are single-walled nanotubes (SWNTs). Two strong peaks located at about 210.6 cm⁻¹ and 271.3 cm⁻¹ were found confirming that SWNTs were grown. The calculated mean diameters based on these peaks are 1.12 and 0.86 nm, respectively, indicating that the synthesized SWNTs have a narrow diameter distribution.

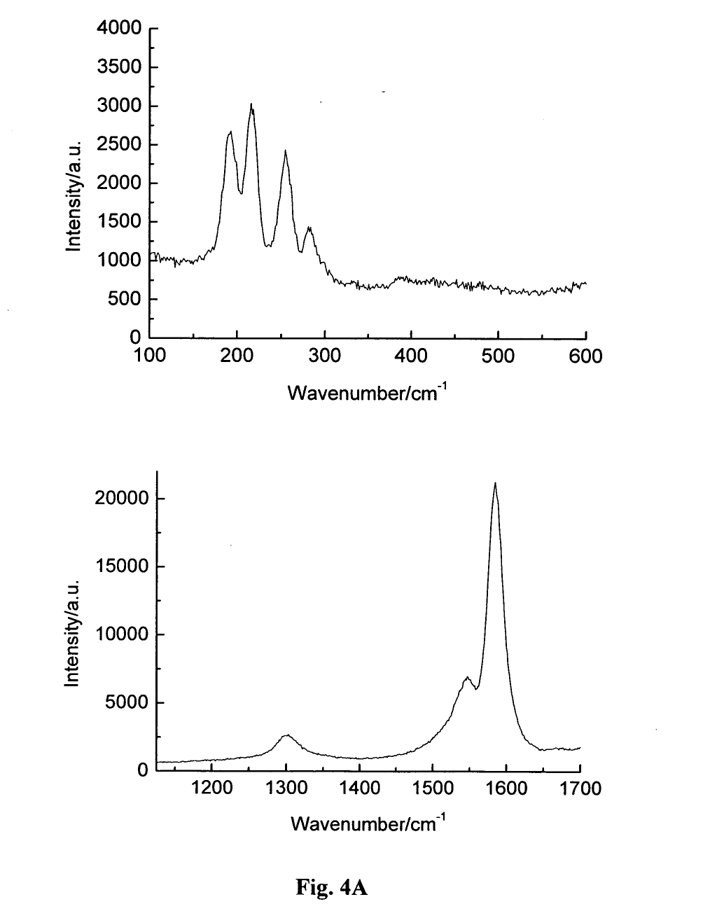

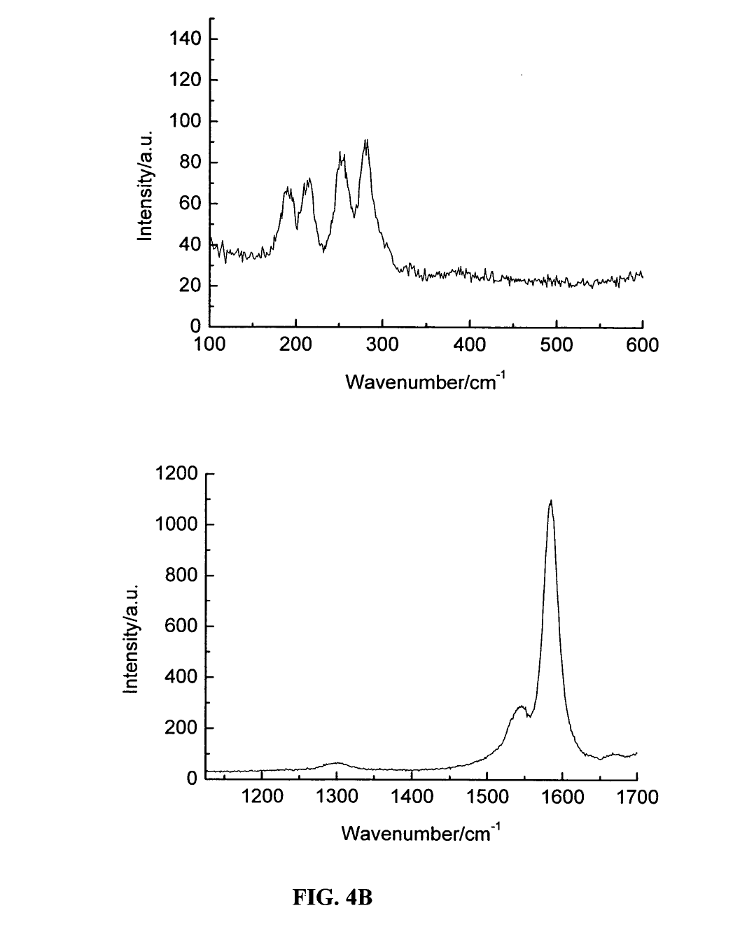

FIGS. 4A and 4B present additional Raman spectra for two different reaction temperatures in both the D- and G-band and RBM regions, indicating the effect of temperature on carbon nanotube diameter and quality. FIG. 4A illustrates the growth of carbon nanotubes using a stainless steel tube pretreated with hydrogen at 900° C. followed by growth of the nanotubes at 900° C. under pure CO at 7.5 atm (about 7.5×10⁵ Pa) for 30 min. FIG. 4B illustrates the growth of carbon nanotubes using a stainless steel tube pretreated with hydrogen at 1000° C. followed by growth of the nanotubes at 1000° C. under pure CO at 7.5 atm (about 7.5×10⁵ Pa) for 30 min. Peaks in both sets of spectra demonstrate the existence of carbon nanotubes with mean diameters of 0.82, 0.90, 1.06, and 1.2 nm. The differences in the spectra indicate different distributions of these nanotubes in the samples. In both cases, the quality of the carbon nanotubes was significantly improved over those nanotubes associated with FIG. 3.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of making carbon nanotubes, the method comprising:
reacting hydrogen and carbon monoxide in a reaction chamber and in the presence of stainless steel; and
forming carbon nanotubes as a result of the reaction.

2. The method of claim 1, wherein reacting hydrogen and carbon monoxide comprises reacting hydrogen and carbon monoxide at a temperature of 650 to 1200° C.

3. The method of claim 2, wherein reacting hydrogen and carbon monoxide comprises reacting hydrogen and carbon monoxide at a temperature of 800 to 1000° C.

4. The method of claim 1, wherein reacting hydrogen and carbon monoxide comprises providing hydrogen and carbon monoxide to the reaction chamber at a pressure in the range of 1 to 10 atm.

5. The method of claim 1, wherein reacting hydrogen and carbon monoxide comprises providing 20% to 100%, by volume, carbon monoxide and 0 to 80%, by volume, hydrogen.

6. The method of claim 1, wherein the stainless steel comprises 316 stainless steel.

7. The method of claim 1, further comprising purging the reaction chamber with inert gas prior to reacting the hydrogen and carbon monoxide in the reaction chamber.

8. The method of claim 1, further comprising providing only hydrogen or an inert gas to the reaction chamber after reacting the hydrogen and carbon monoxide.

9. The method of claim 1, wherein reacting hydrogen and carbon monoxide comprises reacting hydrogen and carbon monoxide for at least 5 minutes.

10. The method of claim 1, wherein the stainless steel comprises a unitary body.

11. The method of claim 1, wherein forming carbon nanotubes comprises forming carbon nanotubes on the stainless steel.

12. The method of claim 11, further comprising removing the carbon nanotubes from the stainless steel.

13. The method of claim 11, further comprising providing hydrogen to the chamber prior to adding carbon monoxide.

14. The method of claim 12, further comprising using the carbon nanotubes in an application.

15. The method of claim 14, wherein the application is a nano-electronic or nano-mechanical application.

16. A composition comprising:
carbon nanotubes formed in the presence of stainless steel.

17. The composition of claim 16, wherein the carbon nanotubes have a mean diameter in the range of 0.8 to 1.2 nm.

18. The composition of claim 16, wherein the carbon nanotubes are devoid of particulate catalyst.

19. The composition of claim 16, wherein the carbon nanotubes are formed on the stainless steel.

20. A device for forming carbon nanotubes, comprising:
a chamber with one or more inlets for receiving gas; and
a stainless steel object disposed in the chamber upon which the carbon nanotubes are formed.

21. The device of claim 20, wherein the stainless steel object is a unitary body.

22. The device of claim 20, wherein the stainless steel object comprises 316 stainless steel.

23. The device of claim 20, wherein the stainless steel object comprises austenitic stainless steel.

24. The device of claim 20, wherein the stainless steel object is suspended in the chamber.
